(19) United States
(12) Patent Application Publication
(10) Pub. No.: US 2015/0274160 A1
(43) Pub. Date: Oct. 1, 2015

(54) THREE-WHEELED TILTING VEHICLE

(71) Applicant: GOTECH INTERNATIONAL LIMITED, Newport Beach, CA (US)

(72) Inventors: Helen Lee, Newport Beach, CA (US); Stephen R. Duffy, Troy, MI (US); Timothy F. McLellan, Viera, FL (US); Ian Bruce, Laguna Nigel, CA (US)

(21) Appl. No.: 14/609,314

(22) Filed: Jan. 29, 2015

Related U.S. Application Data
(63) Continuation of application No. PCT/US2013/052581, filed on Jul. 29, 2013.
(60) Provisional application No. 61/678,043, filed on Jul. 31, 2012.

(51) Int. Cl. B60W 30/045; B62K 5/10; B60W 10/18; B62D 61/08; B60W 10/20; B62K 5/027; B62D 9/02

(52) U.S. Cl. CPC B60W 30/045; B62K 5/027; B62K 5/10; B62D 9/02; B62D 61/08; B60W 10/20; B60W 10/18; B60W 2520/06; B60W 2710/18; B60W 2720/18

(57) ABSTRACT

A three-wheeled tilting vehicle is disclosed. The vehicle can include an electronic control system that controls the tilting of the vehicle in higher speed turns for increased stability. The vehicle may also include a traction control system to provide additional stability during higher speed turns.

### INCORPORATION BY REFERENCE TO ANY PRIORITY APPLICATIONS

Any and all applications for which a foreign or domestic priority claim is identified in the Application Data Sheet as filed with the present application are hereby incorporated by reference in their entirety.

### BACKGROUND OF THE INVENTION

1. Field of the Invention

The invention relates generally to three-wheeled tilting vehicles.

2. Description of the Related Art

The general concept of three-wheeled vehicles that have at least a portion that tilts is well-known in the art. Typically, these vehicles utilize a hydraulic mechanism for controlling the tilting action of a tilting three-wheeled vehicle.

### SUMMARY OF THE INVENTION

In at least one embodiment, the present invention relates to a three-wheeled tilting vehicle that overcomes the shortcomings of the prior art noted above.

In one embodiment, a three-wheeled vehicle includes a rearward chassis portion including a first rear wheel and a second rear wheel; a forward chassis portion including a front wheel and a passenger compartment, wherein the forward chassis portion is rotatable relative to the rearward chassis portion about a tilt axis, and wherein the front wheel is rotatable about a steering axis; a drive unit that drives at least one of the first rear wheel and the second rear wheel; a steering unit that controls a rotational position of the front wheel about the steering axis; and a tilt unit that controls a rotational position of the forward chassis portion about the tilt axis, the tilt unit including a drive gear carried by the rearward chassis portion and a driven gear carried by the forward chassis portion and driven by the drive gear, wherein when the drive gear is rotated in a first direction, the forward chassis portion is tilted in a first direction about the tilt axis and when the drive gear is rotated in a second direction, the forward chassis portion is tilted in a second direction about the tilt axis. The steering unit can further include a force feedback mechanism including at least one actuator and at least one sensor. The three-wheeled vehicle may also include a plurality of sensors, including: a steering input sensor that detects a position of and a torque applied to the steering input device, at least one speed sensor that detects a speed of at least one of the first rear wheel, the second rear wheel and the front wheel, a roll sensor that detects information regarding the vehicle with respect to a roll axis, a yaw sensor that detects information regarding the vehicle with respect to a yaw axis and a transverse acceleration sensor that detects acceleration along a transverse axis; and an electronic control unit that receives information from the plurality of sensors and, based on the information, issues one or more control signals to the steering unit and the tilt unit. In some embodiments, the drive unit, the steering unit and the tilt unit are controlled by the electronic control unit. In some embodiments, the electronic control unit steering unit counter-steers the front wheel to induce rotation of the forward chassis portion about the tilt axis. In some embodiments, the three-wheeled vehicle further includes a traction control arrangement including a first brake and a second brake that selectively apply a braking force to a respective one of the first and second wheels, wherein when the forward chassis portion tilts in a first direction, the first brake is actuated by the electronic control unit and the second brake is not actuated and when the forward chassis portion tilts in a second direction, the second brake is actuated by the electronic control unit and the first brake is not actuated.

In another embodiment, a three-wheeled vehicle includes a rearward chassis portion including a first rear wheel and a second rear wheel; a forward chassis portion including a front wheel and a passenger compartment, wherein the forward chassis portion is rotatable relative to the rearward chassis portion about a tilt axis, and wherein the front wheel is rotatable about a steering axis; a drive unit that drives at least one of the first rear wheel and the second rear wheel; a steering unit that controls a rotational position of the front wheel about the steering axis; a tilt unit that controls a rotational position of the forward chassis portion about the tilt axis; and a traction control arrangement including a first brake and a second brake that receives a signal from an electronic control unit to selectively apply a braking force to a respective one of the first and second wheels, wherein when the forward chassis portion tilts in a first direction, the first brake is automatically actuated and the second brake is not actuated and when the forward chassis portion tilts in a second direction, the second brake is automatically actuated and the first brake is not actuated. In some embodiments, the steering unit further includes a force feedback mechanism including at least one actuator and at least one sensor. In some embodiments, the three-wheeled vehicle further includes a plurality of sensors, including: a steering input sensor that detects a position of and a torque applied to the steering input device, at least one speed sensor that detects a speed of at least one of the first rear wheel, the second rear wheel and the front wheel, a roll sensor that detects information regarding the vehicle with respect to a roll axis, a yaw sensor that detects information regarding the vehicle with respect to a yaw axis and a transverse acceleration sensor that detects acceleration along a transverse axis; and the electronic control unit receives information from the plurality of sensors and, based on the information, issues one or more control signals to the steering unit and the tilt unit. In some embodiments, the electronic control unit is configured to direct the steering unit to counter-steer the front wheel to induce rotation of the forward chassis portion about the tilt axis. In some embodiments, the three-wheeled vehicle further includes a lateral acceleration sensor configured to calculate the vehicle's acceleration in a lateral direction, a yaw sensor configured to provide information on the yaw position of the forward chassis portion, and a roll sensor configured to provide information on the roll position of forward chassis portion.

In yet another embodiment, a three-wheeled vehicle includes a rearward chassis portion including a first rear wheel and a second rear wheel; a forward chassis portion including a front wheel and a passenger compartment, wherein the forward chassis portion is rotatable relative to the rearward chassis portion about a tilt axis, and wherein the front wheel is rotatable about a steering axis; a drive unit that drives at least one of the first rear wheel and the second rear wheel; a tilt unit that controls a rotational position of the forward chassis portion about the tilt axis; a steering unit that controls a rotational position of the front wheel about the steering axis; a steering input device that receives steering input from a user of the vehicle; and an electronic control unit that receives a signal from the steering input device, wherein when the signal received from the steering input device is indicative of a desire to turn in a first direction, the electronic control unit initially counter-steers by rotating the front wheel in a second direction opposite the first direction and subsequently directs the tilt unit to tilt the forward chassis portion in the first direction. In some embodiments, the steering unit further includes a force feedback mechanism including at least one actuator and at least one sensor. In some embodiments, the three-wheeled vehicle further includes a plurality of sensors, including: a steering input sensor that detects a position of and a torque applied to the steering input device, at least one speed sensor that detects a speed of at least one of the first rear wheel, the second rear wheel and the front wheel, a roll sensor that detects information regarding the vehicle with respect to a roll axis, a yaw sensor that detects information regarding the vehicle with respect to a yaw axis and a transverse acceleration sensor that detects acceleration along a transverse axis; and the electronic control unit receives information from the plurality of sensors and, based on the information, issues one or more control signals to the steering unit and the tilt unit. In some embodiments, the electronic control unit receives signals from the at least one speed sensor and the steering input device, wherein when the signal received from the steering input device is indicative of a desire to turn in a first direction and the signal received from the at least one speed sensor is indicative of a vehicle speed above 30 kilometers per hour, the electronic steering control unit directs the steering unit to counter-steer the vehicle and wherein when the signal received from the steering input device is indicative of a desire to turn in a first direction and the signal received from the at least one speed sensor is indicative of a vehicle speed equal to or below 30 kilometers per hour, the electronic steering control unit does not direct the steering unit to counter-steer the vehicle. In some embodiments, the three-wheeled vehicle further includes a traction control arrangement including a first brake and a second brake that selectively apply a braking force to a respective one of the first and second wheels, wherein when the forward chassis portion tilts in a first direction, the first brake is actuated by the electronic control unit and the second brake is not actuated and when the forward chassis portion tilts in a second direction, the second brake is actuated by the electronic control unit and the first brake is not actuated. In some embodiments, the three-wheeled vehicle further includes a lateral acceleration sensor configured to calculate the vehicle's acceleration in a lateral direction, a yaw sensor configured to provide information on the yaw position of the forward chassis portion, and a roll sensor configured to provide information on the roll position of forward chassis portion.

In a further embodiment, a three-wheeled vehicle includes a rearward chassis portion including a first rear wheel and a second rear wheel; a forward chassis portion including a front wheel and a passenger compartment, wherein the forward chassis portion is rotatable relative to the rearward chassis portion about a tilt axis, and wherein the front wheel is rotatable about a steering axis; a drive unit that drives at least one of the first rear wheel and the second rear wheel; a tilt unit that controls a rotational position of the forward chassis portion about the tilt axis; a steering unit that controls a rotational position of the front wheel about the steering axis; a steering input device that receives steering input from a user of the vehicle; and an electronic control unit that receives a signal from the steering input device and a signal from at least one speed sensor, wherein when the signal received from the steering input device is indicative of a desire to turn in a first direction and the signal received from the speed sensor is indicative of a vehicle speed above 30 kilometers per hour, the electronic control unit initially directs the steering unit to counter-steer by rotating the front wheel in a second direction opposite the first direction and subsequently directs the tilt unit to tilt the forward chassis portion in the first direction and wherein when the signal received from the steering input device is indicative of a desire to turn in a first direction and the signal received from the speed sensor is indicative of a vehicle speed below 30 kilometers per hour, the electronic control unit directs the steering unit to steer the front wheel in the first direction and does not direct the tilt unit to tilt the forward chassis portion in the first direction.

In some embodiments, the steering unit further includes a force feedback mechanism including at least one actuator and at least one sensor. In some embodiments, the three-wheeled vehicle further includes a plurality of sensors, including: a steering input sensor that detects a position of and a torque applied to the steering input device, at least one speed sensor that detects a speed of at least one of the first rear wheel, the second rear wheel and the front wheel, a roll sensor that detects information regarding the vehicle with respect to a roll axis, a yaw sensor that detects information regarding the vehicle with respect to a yaw axis and a transverse acceleration sensor that detects acceleration along a transverse axis; and the electronic control unit receives information from the plurality of sensors and, based on the information, issues one or more control signals to the steering unit and the tilt unit. In some embodiments, the electronic control unit receives signals from the at least one speed sensor and the steering input device, wherein when the signal received from the steering input device is indicative of a desire to turn in a first direction and the signal received from the at least one speed sensor is indicative of a vehicle speed above 30 kilometers per hour, the electronic steering control unit directs the steering unit to counter-steer the vehicle and wherein when the signal received from the steering input device is indicative of a desire to turn in a first direction and the signal received from the at least one speed sensor is indicative of a vehicle speed equal to or below 30 kilometers per hour, the electronic steering control unit does not direct the steering unit to counter-steer the vehicle. In some embodiments, the three-wheeled vehicle further includes a traction control arrangement including a first brake and a second brake that selectively apply a braking force to a respective one of the first and second wheels, wherein when the forward chassis portion tilts in a first direction, the first brake is actuated by the electronic control unit and the second brake is not actuated and when the forward chassis portion tilts in a second direction, the second brake is actuated by the electronic control unit and the first brake is not actuated. In some embodiments, the three-wheeled vehicle further includes a lateral acceleration sensor configured to calculate the vehicle's acceleration in a lateral direction, a yaw sensor configured to provide information on the yaw position of the forward chassis portion, and a roll sensor configured to provide information on the roll position of forward chassis portion.

In yet another embodiment, a three-wheeled vehicle includes a rearward chassis portion including a first rear wheel and a second rear wheel; a forward chassis portion including a front wheel and a passenger compartment, wherein the forward chassis portion is rotatable relative to the rearward chassis portion about a tilt axis, and wherein the front wheel is rotatable about a steering axis; a drive unit that drives at least one of the first rear wheel and the second rear wheel; a steering unit that controls a rotational position of the front wheel about the steering axis; a tilt unit that controls a rotational position of the forward chassis portion about the tilt axis; a steering input device that receives steering input from a user of the vehicle; a plurality of sensors, including: a steering input sensor that detects a position of and a torque applied to the steering input device, at least one speed sensor that detects a speed of at least one of the first rear wheel, the second rear wheel and the front wheel, a roll sensor that detects information regarding the vehicle with respect to a roll axis, a yaw sensor that detects information regarding the vehicle with respect to a yaw axis and a transverse acceleration sensor that detects acceleration along a transverse axis; and an electronic control unit that receives information from the plurality of sensors and, based on the information, issues one or more control signals to the steering unit and the tilt unit.

In another embodiment, a method of controlling a three-wheeled vehicle having a rearward chassis portion including a first rear wheel and a second rear wheel, a forward chassis portion including a front wheel and a passenger compartment, wherein the forward chassis portion is rotatable relative to the rearward chassis portion about a tilt axis, and wherein the front wheel is rotatable about a steering axis includes the steps of receiving instructions from a vehicle operator to indicating a turn direction of the vehicle; automatically applying a braking force to one of the first rear wheel and the second rear wheel in the direction of the turn and not to the other of the first rear wheel and the second rear wheel when an electronic control unit receives a signal indicative of a vehicle speed above 30 kilometers per hour; and tilting the forward chassis portion in the direction of the turn. In some embodiments, the method further includes the step of turning the front wheel in a counter-steering direction opposite the turn direction when a speed of the vehicle is above 30 kilometers per hour and subsequent to the turning of the front wheel in the counter-steering direction, tilting the forward chassis portion toward the turn direction.

In another embodiment, a method of controlling a three-wheeled vehicle having a rearward chassis portion including a first rear wheel and a second rear wheel, a forward chassis portion including a front wheel and a passenger compartment, wherein the forward chassis portion is rotatable relative to the rearward chassis portion about a tilt axis, and wherein the front wheel is rotatable about a steering axis includes the steps of detecting an intended turn direction of the vehicle based on user input to a user steering input device; turning the front wheel in a counter-steering direction opposite the intended turn direction; and subsequent to the turning of the front wheel in the counter-steering direction, tilting the forward chassis portion toward the turn direction. In some embodiments, the method further includes the steps of automatically applying a braking force to a one of the first rear wheel and the second rear wheel in the direction of the turn and not to the other of the first rear wheel and the second rear wheel when an electronic control unit receives a signal indicative of a vehicle speed above 30 kilometers per hour.

### BRIEF DESCRIPTION OF THE DRAWINGS

These and other features, aspects, and advantages of the present invention will now be described in connection with an illustrated embodiment of the present invention, in reference to the accompanying drawings. The illustrated embodiments, however, are merely examples and are not intended to limit the invention.

FIG. 1 is a front perspective view of an embodiment of a three-wheeled tilting vehicle according to the present invention.

FIG. 2 is a perspective view of an assembled steer-by-wire steering assembly for one embodiment of a three-wheeled tilting vehicle.

FIG. 3 is a perspective exploded view of the steer-by-wire steering assembly shown in FIG. 2.

FIG. 4 is a schematic illustration of steering inputs and response to the steering inputs by the steer-by-wire steering assembly shown in FIGS. 2 and 3.

FIG. 5 is a schematic illustration of the interaction between the steer-by-wire steering assembly, front wheel assembly, tilt control assembly, propulsion module and rear wheel steering assembly, and electronic steering control system according to one embodiment of the present invention.

FIG. 6 is a schematic illustration of a side and front view of a three-wheeled tilting vehicle showing the roll axis around which the forward chassis portion may tilt, according to one embodiment.

FIG. 7 is an illustration of a lower-speed turn of a three-wheeled tilting vehicle according to one embodiment of the present invention.

FIG. 8 is an illustration of a higher-speed turn of a three-wheeled tilting vehicle according to one embodiment of the present invention.

FIGS. 9A-C are schematic illustrations of one embodiment of a three-wheeled tilting vehicle shown in a neutral orientation, a moderately tilted orientation, and a tilt plus counter-steer orientation.

### DETAILED DESCRIPTION OF THE PREFERRED EMBODIMENT

The following detailed description is directed to certain specific embodiments of the invention. However, the invention may be embodied in a multitude of different ways as defined and covered by the claims.

Embodiments of the invention can provide the features of a three-wheeled tilting vehicle. Some embodiments of the vehicle desirably may incorporate an electronic steering and tilt control assembly that utilizes a variety of sensors, including a yaw sensor, to control the vehicle or predict conditions which could lead to instability or loss of control. Other embodiments of the vehicle may incorporate a traction control mechanism that uses independent braking. Additional embodiments of the vehicle may incorporate counter-steering to induce vehicle lean or tilting of the three-wheeled vehicle. Further embodiments of the vehicle may incorporate a single electric tilt actuator to control the tilt of the three-wheeled vehicle. Other embodiments may incorporate traction control systems to control the speed of the rear wheels of a three-wheeled tilting vehicle to provide greater stability and control during turns.

### Overview—Vehicle

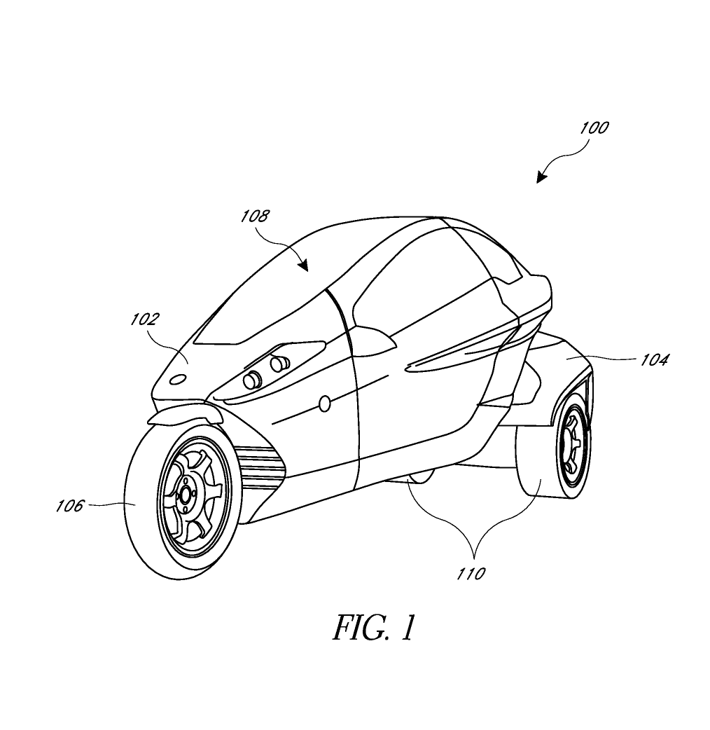

One embodiment of the present invention comprises a three-wheeled vehicle 100 as shown in FIG. 1. The three-wheeled vehicle 100 is preferably comprised of a forward chassis portion 102 and a rearward chassis portion 104. The two chassis portions are preferably rotatably connected such that the forward chassis portion 102 may rotate or tilt relative to the rearward chassis portion 104 about a longitudinal or tilt axis. The forward chassis portion 102 preferably further comprises a front wheel 106 and a passenger compartment 108. The front wheel 106 can be turned about a front wheel steering axis. The passenger compartment 108 is preferably suspended such that it may be rotatable about the tilt axis. The rearward chassis portion 104 preferably further comprises two rear wheels 110. The passenger compartment 108 may further comprise seating for at least one passenger, as well as provide cargo space.

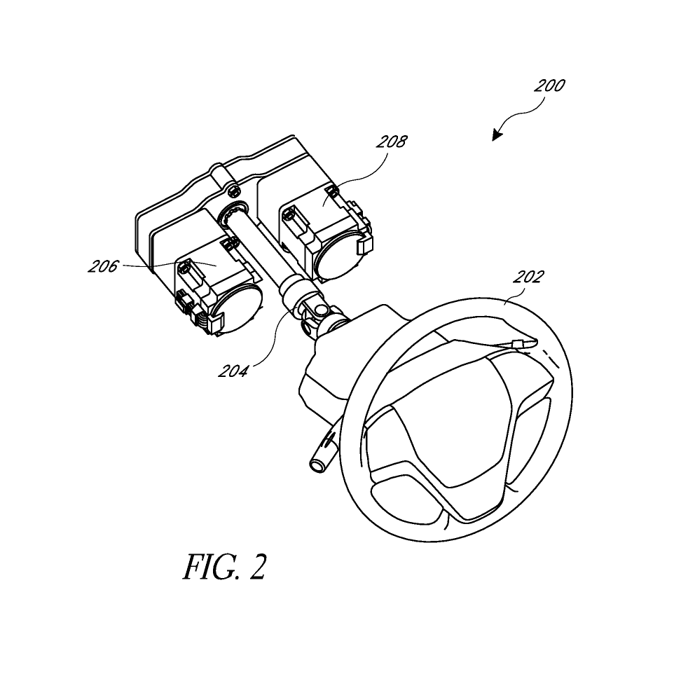

The three-wheeled vehicle 100 is preferably electronically controlled by an electronic or steer-by-wire steering control assembly 200 such as that shown in FIG. 2. Other three-wheeled tilting vehicle designs included hydraulic mechanisms to tilt the vehicle. However, a hydraulic mechanism is heavy, difficult to maintain, and not as responsive as an electronic control assembly. The steer-by-wire steering control assembly 200 takes the input of a variety of sensors and optimizes the steering and tilt control of the vehicle 100 for a wide range of driving conditions. In other embodiments, including the illustrated embodiment, the vehicle 100 may also include a traction control mechanism that can control the rotation of the rear wheels for additional stability in turns. Additional embodiments, including the illustrated embodiment, may comprise a control mechanism that produces counter-steering to induce tilt or lean. Still further embodiments, including the illustrated embodiment, may comprise a vehicle with a single tilt actuator to lean or tilt the passenger compartment. These embodiments will be discussed in further detail below.

### Overview—Steer-by-Wire

The vehicle of the present invention uses a steer-by-wire assembly wherein the steering, motor control, and leaning of the front section of the vehicle are controlled by various sensors, actuators, and computers. The steering wheel input, as well as the accelerator and braking inputs, are received by an electronic control unit (“ECU”) which then computes the necessary signals to send to the various actuators and motors that control the steering, leaning, and propulsion of the vehicle.

The benefits of a steer-by-wire assembly include increased efficiency, since the electric power steering motor only needs to provide assistance when the steering wheel is turned, whereas a hydraulic pump must run constantly. Additionally, an environmental advantage may be realized due to the elimination of the hazard posed by leakage and disposal of hydraulic fluid. Furthermore, a steer-by-wire assembly may provide additional advantages in terms of vehicle maneuverability and responsiveness. Unlike a conventional mechanical or hydraulic mechanism, a steer-by-wire assembly may be able to provide a near instantaneous response to a driver input, eliminating the lag often found in conventional mechanical or hydraulic mechanisms. And finally, a steer-by-wire assembly may also provide enhanced vehicle stability due to the ability of the assembly to quickly adapt to changing road or vehicle conditions. In terms of driver comfort and experience, a steer-by-wire assembly may eliminate the noise, vibration, and harshness effects due to the driving surface that may be transmitted to the driver via the wheels. Additionally, the driver experience could be enhanced by a steer-by-wire assembly which allows the driver to change those characteristics typically fixed in mechanical and hydraulic mechanisms, such as steering ratio and steering effort, in order to optimize the steering response and feel for the driver.

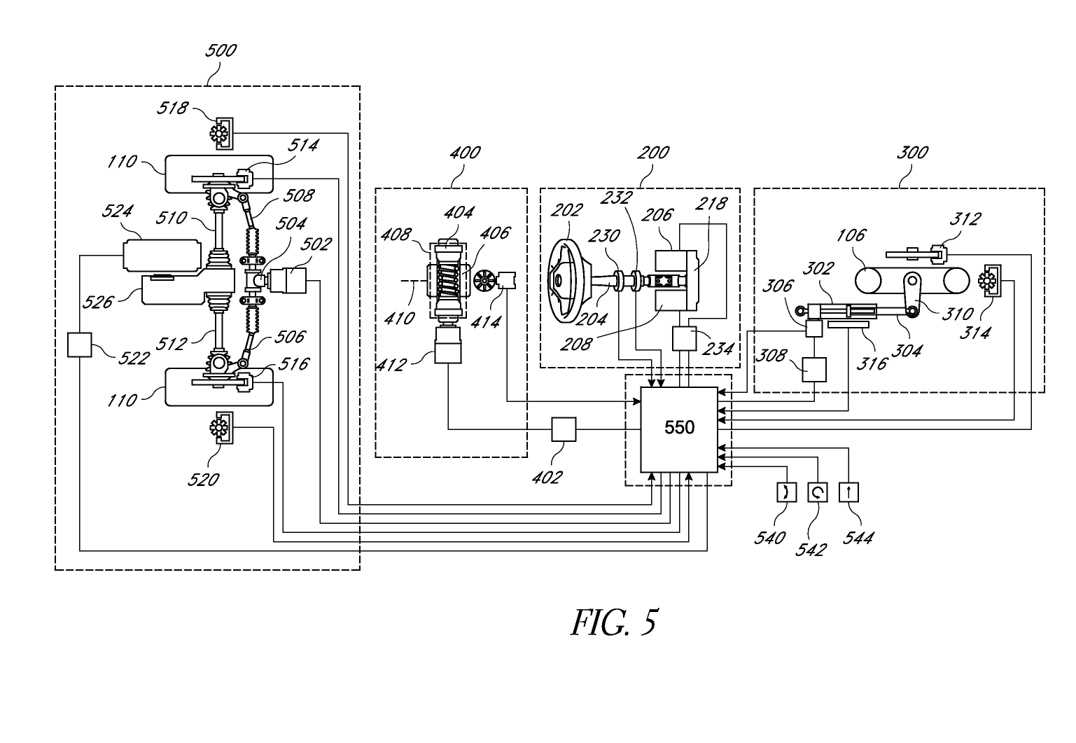

A steer-by-wire assembly composed of modular sub-assemblies is illustrated in FIG. 5. Each of these sub-assemblies will be discussed in greater detail below. By incorporating a plurality of sensors, for example, a steering input sensor that detects a position of and a torque applied to a steering input device such as a steering wheel, at least one speed sensor that detects a speed of at least one of the rear wheels or the front wheel, a roll sensor that detects information regarding the vehicle with respect to a roll axis, a yaw sensor that detects information regarding the vehicle with respect to a yaw axis and a transverse acceleration sensor that detects acceleration along a transverse axis, an electronic control unit can receive and process this information from the plurality of sensors and, based on the information, issues one or more control signals to the steer and tilt the vehicle.

### Steer-by-Wire Steering Sub-Assembly

One advantage of a steer-by-wire assembly such as that shown in the illustrated embodiments is that the entire steering sub-assembly may be designed and installed as a modular unit, such as that shown in FIG. 2.

FIGS. 2-4 illustrate an embodiment of a steer-by-wire steering sub-assembly in which steering control to the front wheel and one or both of the rear wheels is achieved electronically through a force feedback mechanism consisting of actuators and electronic sensors. The steering sub-assembly 200 can, in some embodiments, control a rotational position of the front wheel about a steering axis. Traditional steering input devices, such as a steering wheel and steering column, may be provided to enable the driver to more easily transition to a steer-by-wire assembly from a more conventional mechanical or hydraulic steering mechanism.

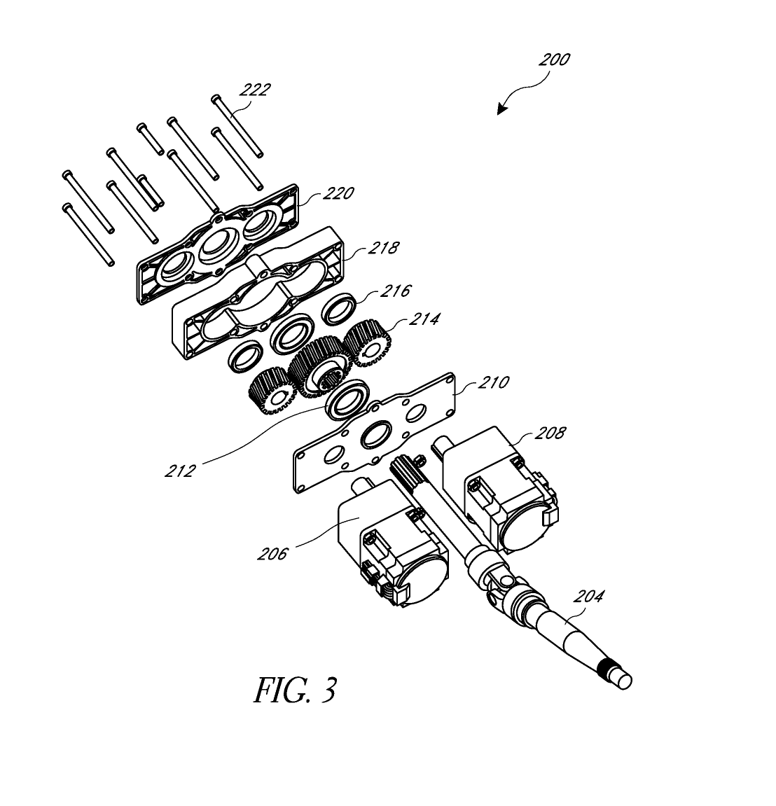

In the illustrated embodiment of the steering sub-assembly 200 shown in FIGS. 2 and 3, a steering input device 202 such as a steering wheel is desirably provided to the driver of the vehicle within the passenger compartment. The steering input device 202 is preferably connected to a steering shaft 204. Also positioned within the steering assembly 200 are dual feedback actuators 206, 208. The feedback actuators 206, 208 are electronically connected to a steering feedback controller which sends and receives information from the electronic steering control module (ESC) of the vehicle. The feedback actuators 206, 208 may be located on either side of the steering shaft 204. In some embodiments, only one feedback actuator may be installed in the steering sub-assembly. In the illustrated embodiment, a steering gearbox 218 may be provided which contains three helical gears which translate the signals from the dual actuators into a steering feedback response to the steering shaft. The helical gears 214 are attached to ends of the two feedback actuators 206, 208 and the steering shaft 204 as shown. In some embodiments, the gearbox 218 is made from composite materials to reduce weight. A cover plate 220 is attached to the end of the gearbox 218 and the gearbox assembly including the helical gears 214, the gearbox 218, and bearings 214, 216 is mechanically attached to the feedback actuators 206, 208 and the steering shaft 204 by mechanical fasteners such as attachment bolts 222. The steering shaft 204 may incorporate a universal joint (U joint) 224 to accommodate steering wheel tilt and allow the steering wheel 202 to be positioned up or down depending on user comfort and desired steering position. The U-joint 224 also allows the actuators and gearbox assembly to be installed behind the forward firewall to better control unwanted sound.

In some embodiments, the steering shaft 204 may include a plurality of sensors. These sensors may include a steering position sensor and a steering torque sensor. These sensors desirably provide the position of the front wheel 106. Alternatively, optical encoders may provide the wheel position. The electronic steering control (ESC) unit receives input information from the steering position sensor and the steering torque sensor and uses this information to provide control signals to the front wheel steering motor controller, discussed below.

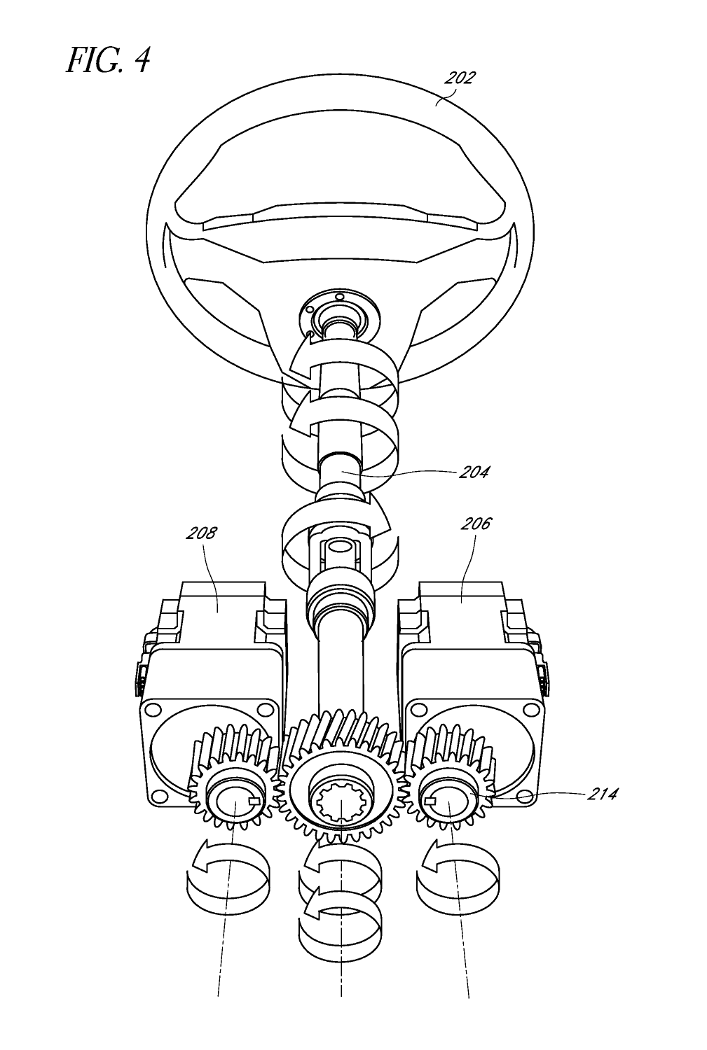

FIG. 4 illustrates the helical gearset 214 which translates the signals from the dual actuators 206, 208 into a steering feedback response to the steering shaft 204. The dual feedback actuators 206, 208 preferably provide redundancy and have a 180 degree relationship to the other. They are preferably identically configured and perform a substantially identical function. Separate shaft-mounted steering position and torque sensors may be unnecessary in some configurations since desirably the feedback actuators 206, 208 contain highly accurate digital encoders which can determine an externally imposed or driver directed torque directly. However, the steering position and torque sensors may be included in some configurations of the assembly for additional redundancy and safety. In the event of an actuator failure, the remaining actuator is preferably fully capable of performing all desired functions, with only a minor loss of high-end feedback torque. Steering control is therefore preferably unaffected. Furthermore, steering wheel rotation beyond 270 degrees lock-to-lock may be unnecessary which results in a maximum of 360 degree actuator rotation at a 3:4 input gear ratio, for some configurations including the illustrated configuration.

The steer-by-wire steering assembly 200, as well as the other vehicle sub-assembly systems such as the front wheel sub-assembly 300, the tilt control sub-assembly 400, and the propulsion module and rear wheel steering sub-assembly 500, is illustrated in FIG. 5 and is discussed in further detail below.

As discussed above with respect to FIGS. 2-4, the steer-by-wire steering sub-assembly 200 includes a steering wheel 202 connected to a steering shaft 204. The steering shaft 204 and dual feedback actuators 206, 208 are connected to a steering gearbox 218 containing a set of helical gears which translate the signals from the actuators 206, 208 to a steering feedback response. The dual feedback actuators 206, 208 are connected to a steering feedback controller 234. In some configurations, a steering position sensor 230 and a steering torque sensor 232 may be positioned on the steering shaft 204 for additional redundancy and safety in case of failure of one or more of the dual feedback actuators 206, 208. The steering feedback controller 234, the steering position sensor 230 and the steering torque sensor 232 are electronically connected to the electronic steering control (ESC) unit that incorporates the feedback from a number of sensors positioned on the vehicle and translates this information into signals that may be used to control the steering of the three-wheeled tilting vehicle.

### Front Wheel Sub-Assembly

The front wheel sub-assembly 300 of one embodiment of a three-wheeled tilting vehicle is shown in FIG. 5. The front wheel sub-assembly 300 includes a front wheel 106 connected to a front wheel steering arm 310. The steering arm 310 is further connected to a front wheel steering (FWS) actuator 302 through an actuator rod 304. The FWS actuator 302 is desirably controlled by the front wheel steering motor 306 which receives a control signal via the FWS motor controller 308 from the ESC 550. A forward speed sensor 314 and a linear position sensor 316 provide information to the ESC 550 that may be used to help steer the vehicle. The front wheel 106 may be steered about a front wheel steering axis, said steering determined by a control signal from the ESC 550. The front caliper 312 provides braking force to the front wheel 106 based on a control signal received from the ESC 550. The steer-by-wire sub-assembly 200, along with the front wheel sub-assembly 300, is desirably able to counter-steer the front wheel 106 during the initial stages of a higher speed turn, or leaning turn, as will be discussed in further detail below.

### Tilt Control Sub-Assembly

As mentioned above, the passenger compartment is preferably suspended above the chassis and allowed to rotate with respect to a horizontal and longitudinal tilt axis of the chassis. The passenger compartment may tilt in response to a turn or other condition in which the ESC determines that a tilt response is appropriate. In one embodiment, the tilt of the vehicle is desirably controlled electronically through the tilt control sub-assembly. The tile control sub-assembly controls a rotational portion of the forward chassis portion about a tilt axis. The tilt control sub-assembly 400 of one embodiment of the vehicle as shown in FIG. 5 desirably consists of a single electric tilt actuator 408 with a worm gear drive 404. The actuator 408 is preferably mounted to the tilting passenger compartment with the mounting assembly 406. An optical bank encoder 414 desirably provides the ESC 550 with the angle of the tilting passenger compartment versus the non-tilting chassis. After receiving a signal from the ESC 550, preferably a tilt motor 412 provides the force needed to tilt the passenger compartment via the worm gear drive 404 contained within the tilt actuator 408.

The worm gear drive 404 of the tilt control sub-assembly 400 comprises a drive gear carried by the rearward chassis portion 104 and a driven gear carried by the forward chassis portion 102. The driven gear is driven by the drive gear such that when the drive gear is rotated in a first direction, the forward chassis portion 102 is tilted in a first direction about a horizontal and longitudinal, or tilt, axis and when the drive gear is rotated in a second direction, the forward chassis portion 102 is tilted in a second direction about the tilt axis. In comparison to previous tilting vehicles, the tilting force is provided by a single actuator assembly rather than a hydraulic system. In some embodiments, a lost motion coupling or clutch can allow limited tilt of the forward chassis portion without back driving the tilt control sub-assembly. As will be discussed in further detail below, the load on the actuator assembly is reduced by electronically-controlled counter-steering of the front wheel which induces lean of the vehicle, at which point the actuator and gear assembly provide additional force to tilt the vehicle.

### Propulsion Module/Rear Wheel Steering Sub-Assembly

FIG. 5 further illustrates one configuration of a propulsion module and rear wheel steering sub-assembly 500 of the three-wheeled tilting vehicle. The propulsion module and rear wheel steering sub-assembly 500 are preferably located in the rearward chassis portion 104. The rearward chassis portion 104 preferably comprises two rear wheels 110. The rear wheels 110 are connected via a drive shaft 510, 512 to a continuously variable transmission (CVT) 526. The transmission 526 is driven by a drive motor 524 which receives signals from the ESC 550 via the drive motor controller 522. In one configuration, the drive motor 524 is desirably a 30-40 kW motor. The rear wheels 110 are connected via rear wheel steering arms 506, 508 to a steering rack assembly 504 and a rear wheel steering actuator 502. The rear wheel steering actuator 502 is driven by signals received from the ESC 550 and allows for independent steering of the rear wheels 110. Two rear wheel speed sensors 518, 520 are provided to determine the speed of the rear wheels 110 and provide this information to the ESC 550 for use in determining vehicle driving conditions, such as vehicle instability due to higher speed or turning, and providing appropriate response signals to the other components of the vehicle steering assembly shown in FIG. 5.

The power source for the drive motor could be an internal combustion engine that drives a generator or the power source could be a bank of batteries. In some configurations, the batteries could include lithium-ion battery packs or nickel-metal hydride (NiMH) batteries, however other battery types may be used. In some embodiments, a battery management system to maximize power usage and storage could also be included in the propulsion module. The battery management system could be configured to manage the monitoring, control, and safety circuitry of the battery packs and battery control systems, including accurately monitoring cell charges, balancing voltages between battery cells to maintain a constant voltage across battery packs, managing charging and discharging, and protecting the system from over-voltage and under-current conditions.

### Electronic Steering Control Module

The electronic steering control module (ESC) 550 shown in FIG. 5 can preferably receive inputs from the variety of sensors located throughout the vehicle. The ESC 550 preferably can also perform sophisticated calculations to control and even predict conditions which could lead to vehicle instability or loss of control. For example, in one embodiment, the vehicle's ESC 550 could be adapted to tilt the vehicle during slower speed turns for certain situations, such as during evasive maneuvers or when sharp turns at slower speed are required. This is desirably accomplished by a selected programming of the ESC 550. Additionally, the vehicle's ESC 550 could be programmed to counter-steer the front wheel of the vehicle for turns above a specified speed, which would induce vehicle lean.

### Three-Wheeled Vehicle Incorporating Yaw Sensor to Optimize Tilt and Steering

FIG. 5 further illustrates that one configuration of the three-wheeled tilting vehicle desirably incorporates a variety of sensors to provide feedback on a wide range of driving conditions. These conditions may include, for example, road conditions, front and rear wheel speed, lateral acceleration, roll angle, and yaw position. By incorporating the feedback from the sensors, the ESC 550 can calculate whether to tilt the vehicle for optimized stability or slow down or speed up the wheels during a turn or other maneuver, among other responses. The vehicle's response to various driving conditions is preferably accomplished by selective programming of the ESC 550. These algorithms and/or control programs may be used to control the tilting and steering of the vehicle in response to specific driving conditions. The vehicle's response to an instability condition is described in further detail below.

The front wheel speed sensor 314 and rear wheel speed sensors 518, 520 may be coupled to the respective front wheel 106 or rear wheels 110 or to one of the drive shafts of the wheels. These sensors may generate a pulse signal having a frequency proportional to the speed, which can be transformed into a useful electronic control signal. Other possibilities for measuring speed of the front and rear wheels may also be used.

A lateral acceleration sensor 544 may be used to calculate the vehicle's acceleration in a lateral direction, such as when turning or sliding. Some conventional acceleration sensors may be available in single or double-axis versions such that they can measure acceleration in both a lateral and a longitudinal direction of the vehicle. With this sensor, it is possible to obtain an indication of the vehicle speed using a second signal, which may be used to detect a fault in the primary speed measurement and initiate appropriate actions, such as warning the driver or activating a fault mode response program. A roll sensor 540 and a yaw sensor 542 may also be used to provide information on the position of the tilting forward chassis portion 102.

Three-Wheeled Vehicle with Traction Control for Stability in Turns

Traction control systems are typically a secondary function of the anti-lock braking system on a vehicle and are designed to prevent loss of traction of driven wheels. Traction control is typically used to prevent a difference between traction of different wheels which may result in a loss of road grip that compromises steering control and stability of vehicles. For three-wheeled vehicles, which have an inherent instability greater than four wheeled vehicles, the use of traction control systems may be especially beneficial.

A disadvantage of three-wheeled leaning vehicles is that the rear wheels can lose traction during higher speed turns. The vehicle of the present invention addresses this problem by integrating a traction control assembly to the steer-by-wire assembly, in some configurations. The traction control assembly uses the vehicle's braking mechanism to slow the inside wheel during a turn to maintain rear wheel contact with the ground and control of the vehicle during higher speed turns. As shown in FIG. 5, the rear wheel brake calipers 514, 516, components of one configuration of a traction control system, receive signals from the ESC 550 to slow one or both of the rear wheels to maintain vehicle stability when turning.

Difference in wheel slip may occur due to the vehicle turning or varying road conditions. During a higher speed turn, the traction control system may control the wheel speeds such that the outer and inner wheels of a vehicle are subjected to different speeds of rotation. For example, the inner rear wheel of the vehicle may be slowed during a turn to maintain the inner rear wheel's contact with the ground. The traction control system may be triggered when the electronic control system registers sensor readings from the wheel speed sensors that indicate that one of the driven wheels is spinning significantly faster than the other. The electronic control system, part of the traction control assembly, will use the vehicle's braking mechanism to slow down the rear wheel on the inside of the turn such that it will remain in contact with the road surface.

### Instability in Turns—Rollover

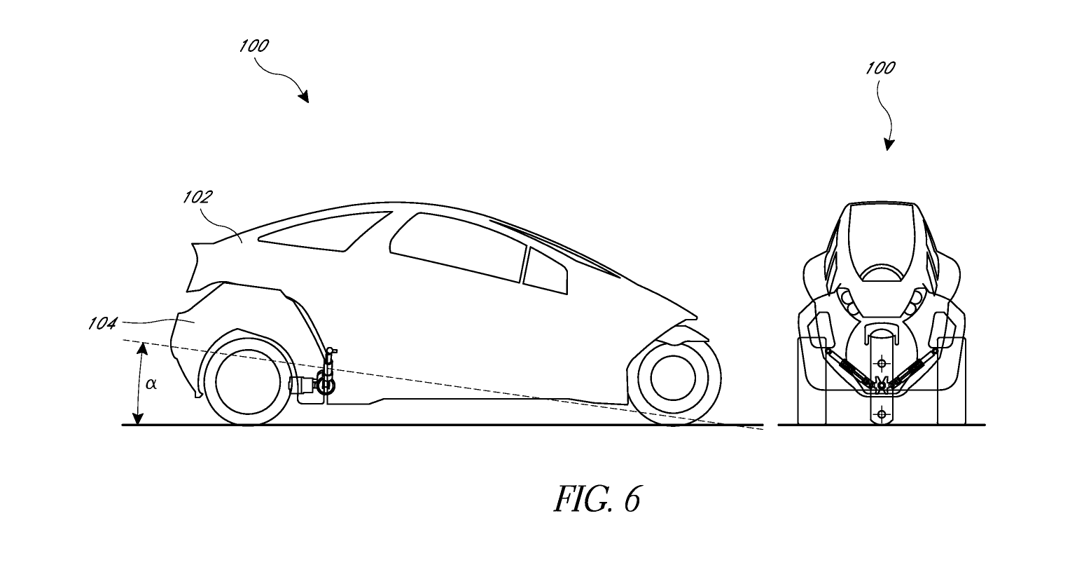

FIG. 6 illustrates a roll or tilt axis on one configuration of a three-wheeled tilting vehicle. At the most fundamental level, a vehicle's rollover threshold is established by the simple relationship between the height of the center of gravity (CG) and the maximum lateral forces capable of being transferred by the tires. Modern tires can develop a friction coefficient as high as 0.8, which means that the vehicle can negotiate turns that produce lateral forces equal to 80 percent of its own weight (0.8 g) before the tires loose adhesion. The center of gravity height in relation to the effective half-tread of the vehicle determines the L/H ratio which establishes the lateral force required to overturn the vehicle. As long as the side-force capability of the tires is less than the side-force required for overturn, the vehicle will slide before it overturns.

Rapid onset turns impart a roll acceleration to the body that can cause the body to overshoot its steady-state roll angle. This can happen in a variety of conditions, such as: sudden steering inputs; when a skidding vehicle suddenly regains traction and begins to turn again; and when a hard turn in one direction is followed by an equally hard turn in the opposite direction (slalom turns). The vehicle's roll moment depends on the vertical displacement of the center of gravity above its roll center. The degree of roll overshoot depends upon the balance between the roll moment of inertia and the roll damping characteristics of the suspension. An automobile with 50 percent (of critical) damping has a rollover threshold that is nearly one third greater than the same vehicle with zero damping.

Overshooting the steady-state roll angle can lift the inside wheels off the ground, even though the vehicle has a higher static margin of safety against rollover. Once lift-off occurs, the vehicle's resistance to rollover diminishes exponentially, which rapidly results in a condition that can become virtually irretrievable. The roll moment of inertia reaches much greater values during slalom turns wherein the forces of suspension rebound and the opposing turn combine to throw the body laterally through its roll limits from one extreme to the other. The inertial forces involved in overshooting the steady-state roll angle can exceed those produced by the turn-rate itself.

A simple way to model a non-leaning three-wheeler's margin of safety against rollover is to construct a base cone using the CG height, its location along the wheelbase, and the effective half-tread of the vehicle.

Maximum lateral G-loads are determined by the tire's friction coefficient. Projecting the maximum turn-force resultant toward the ground forms the base of the cone. A one-G load acting across the vehicle's CG, for example, would result in a 45 degree projection toward the ground plane. If the base of the cone falls outside the effective half-tread, the vehicle will overturn before it skids. If it falls inside the effective half-tread, the vehicle will skid before it overturns.

One embodiment of the present invention discloses a 1F2R vehicle (one front, two rear tire) design where the single front wheel and passenger compartment lean into turns, while the rear section, which carries the two side-by-side wheels and the powertrain, does not. The two sections are connected by a mechanical pivot. Tilting three-wheelers (TTWs) offer increased resistance to rollover and much greater cornering power—often exceeding that of a four-wheel vehicle. An active leaning assembly preferably does not require a wide, low layout in order to obtain higher rollover stability. Allowing the vehicle to lean into turns desirably provides much greater latitude in the selection of a CG location and the separation between opposing wheels.

The rollover threshold of this type of vehicle depends on the rollover threshold of each of the two sections taken independently. The non-leaning section behaves according to the traditional base cone analysis. Its length-to-height ratio determines its rollover threshold. Assuming there is no lean limit on the leaning section, it would behave as a motorcycle and lean to the angle necessary for balanced turns. The height of the center of gravity of the leaning section is unimportant, as long as there is no effective lean limit.

It is important to note that the rollover threshold of a TTW is determined by the same dynamic forces and geometric relationships that determine the rollover threshold of conventional vehicles—except that the effects of leaning become a part of the equation. As long as the lean angle matches the vector of forces in a turn, then, just like a motorcycle, the vehicle has no meaningful rollover threshold. In other words, there will be no outboard projection of the resultant in turns, as is the case with non-tilting vehicles.

In a steadily increasing turn, the vehicle will lean at greater and greater angles, as needed to remain in balance with turn forces. Consequently, the width of the track is largely irrelevant to rollover stability under free-leaning conditions. With vehicles having a lean limit, however, the resultant will begin to migrate outboard when the turn rate increases above the rate that can be balanced by the maximum lean angle. Above lean limit, loads are transferred to the outboard wheel, as in a conventional vehicle.

The rollover threshold of a vehicle without an effective lean limit will be largely determined by the rollover threshold of the non-leaning section. But the leaning section can have a positive or negative effect, depending on the elevation of the pivot axis at the point of intersection with the centerline of the side-by-side wheels. If the pivot axis (the roll axis of the leaning section) projects to the axle centerline at a point higher than the center of the wheels, then it will reduce the rollover threshold established by the non-leaning section. If it projects to a point that is lower than the center of the side by-side wheels, then the rollover threshold will actually increase as the turn rate increases. In other words, the vehicle will become more resistant to overturn in sharper turns. If the pivot axis projects to the centerline of the axle, then the leaning section has no effect on the rollover threshold established by the non-leaning section.

### Counter-Steering Used to Induce Vehicle Lean

The steer-by-wire system is desirably able to counter-steer the front wheel during the initial stages of a higher speed turn, or a leaning turn. Counter-steering is the non-intuitive steering of the front wheel in the opposite direction of a turn to induce leaning into the turn. Counter-steering of the front wheel may be controlled by the electronic control unit. When the electronic control unit receives a signal from the steering input device, indicative of a desire to turn in a first direction, the electronic steering control sub-assembly initially counter-steers the vehicle by rotating the front wheel in a direction opposite the direction of the turn. The electronic control unit also directs the tilt sub-assembly to tilt the forward chassis portion of the vehicle in the direction of the turn. Counter-steering is also dependent on the speed of the vehicle when turning. In some embodiments, when the signal received by the electronic control unit from the steering input device is indicative of a desire to turn in a first direction and the signal received from the at least one speed sensor is indicative of a vehicle speed above 30 kilometers per hour, the electronic steering control unit counter-steers the vehicle. When the signal received from the steering input device is indicative of a desire to turn in a first direction and the signal received from the at least one speed sensor is indicative of a vehicle speed equal to or below about 30 kilometers per hour, the electronic steering control unit does not counter-steer the vehicle. In other embodiments, the vehicle may be counter-steered if the speed is above about 35 kilometers per hour, if the vehicle speed is above about 40 kilometers per hour, and if the vehicle speed is above about 45 kilometers per hour. Counter-steering vastly reduces the amount of torque required to induce leaning of the front section of the vehicle. After the lean is initiated, the front wheel can be turned into the turn to complete the turn.

### Single Electric Tilt Actuator

In order to lean the forward chassis portion of the vehicle, a single actuator is coupled to the rear portion and the front portion. A drive gear may be mounted to the rear chassis portion while a driven gear is mounted to the forward, tilting, chassis portion. As discussed above with respect to FIG. 5, the single electronic actuator may comprise a worm gear that is rotated by a motor to lean the front portion of the vehicle relative to the rear portion. Peak torque loads on the actuator typically occur at roll or lean initiation and recovery. The three-wheeled vehicle may be induced to lean via counter-steering of the front wheel during higher speed turns. Vehicle lean or tilt may also be initiated by the ESC at times when a vehicle instability condition is recorded, based on information from various sensors including the speed sensors, roll, yaw, and transverse acceleration sensors.

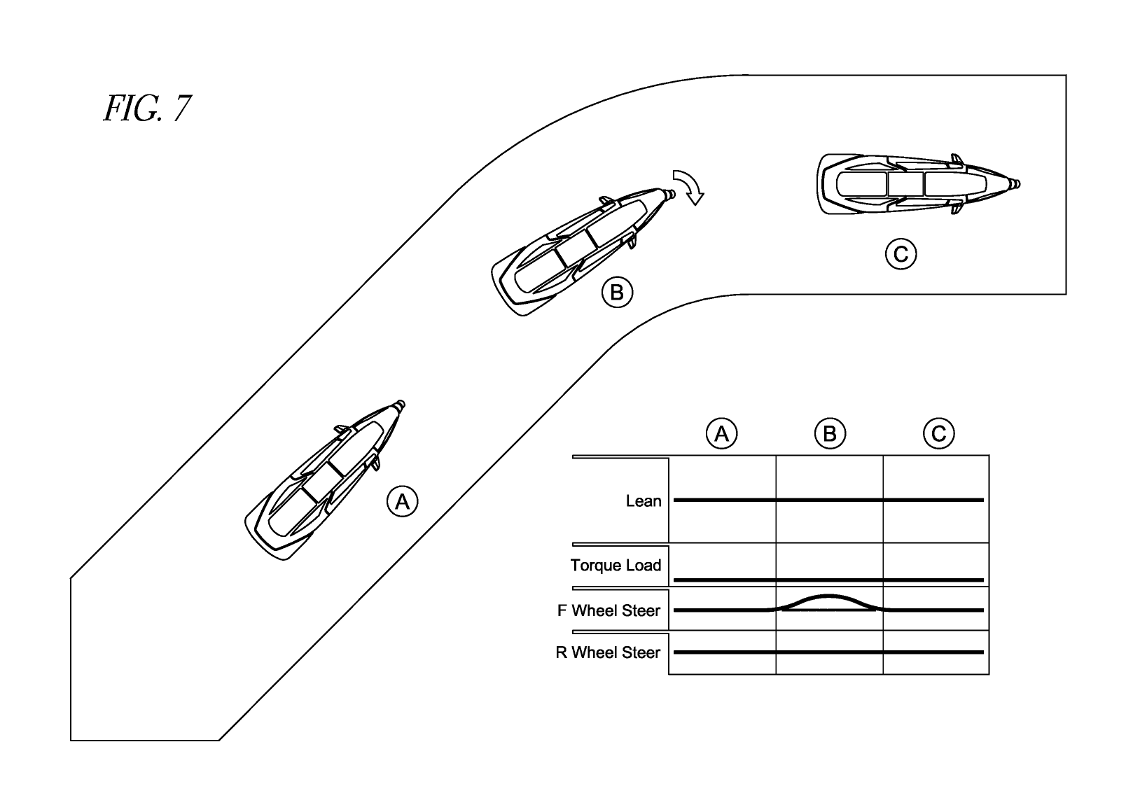

In some configurations, tilting or leaning the vehicle may require as much as approximately 1000 N-m of force from the actuator to lean the forward chassis portion into the turn without the assistance of counter-steering. As discussed above, counter-steering the front wheel during a turn can induce lean in the forward chassis portion and reduce the force required to tilt or lean the forward chassis portion to between approximately 0 and 200 N-m in some configurations. FIG. 7 illustrates a lower-speed turn in which the front wheel of the vehicle is turned in the direction of the turn. A lower-speed turn may be a turn taken at a vehicle speed of up to about 30 km/h. In other configurations, a lower-speed turn may be taken at a vehicle speed of between about 15 and 45 km/h. As indicated, for a lower-speed turn, vehicle lean is generally not required. In some configurations, including the illustrated configuration, the rear wheels are not steered in a lower-speed turn.

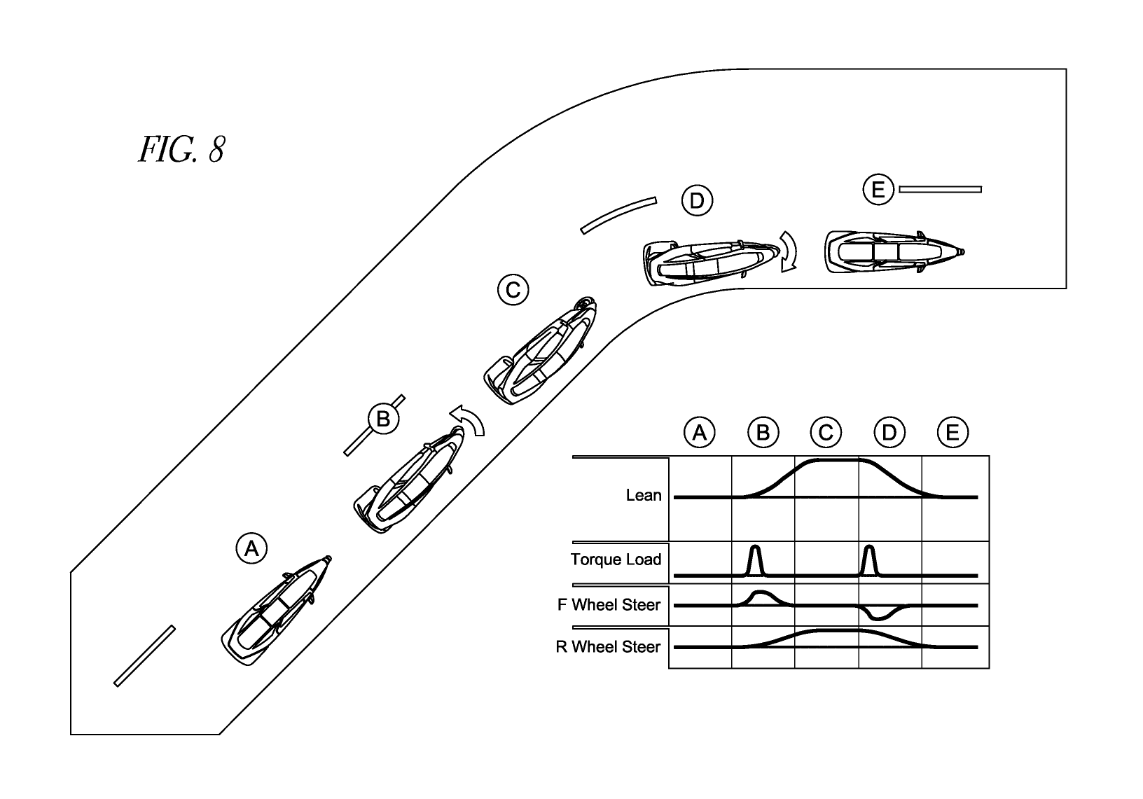

A higher-speed turn is illustrated in FIG. 8. A higher-speed turn may be a turn taken at a vehicle speed of up to about 80 km/h. In other configurations, a higher-speed turn may be taken at a vehicle speed of between about 40 km/h and 90 km/h. At point A, the vehicle is preparing to enter the turn. At point B, the front wheel of the vehicle is counter-steered, or steered in the opposite direction of the turn, to induce vehicle lean. At point B, the forward chassis portion of the vehicle has started to lean into the turn. At point C, the forward chassis portion has reached maximum lean into the turn. The front wheel of the vehicle remains in a counter-steered position. At point D, the forward chassis portion has leaned back toward a central, or neutral, position though some lean into the turn remains. The front wheel of the vehicle is turned into the turn to help complete the vehicle's turn. At point E, the forward chassis portion has returned to a fully neutral, or non-leaning, position.

As discussed above, traction control can help steer the vehicle through a turn. As indicated by the graph in FIG. 8, the rear wheels are turned into the turn at around the apex of the turn, as indicated at point C. By turning and slowing the inside rear wheel using the traction control system, the vehicle can desirably maintain stability in a higher-speed turn.

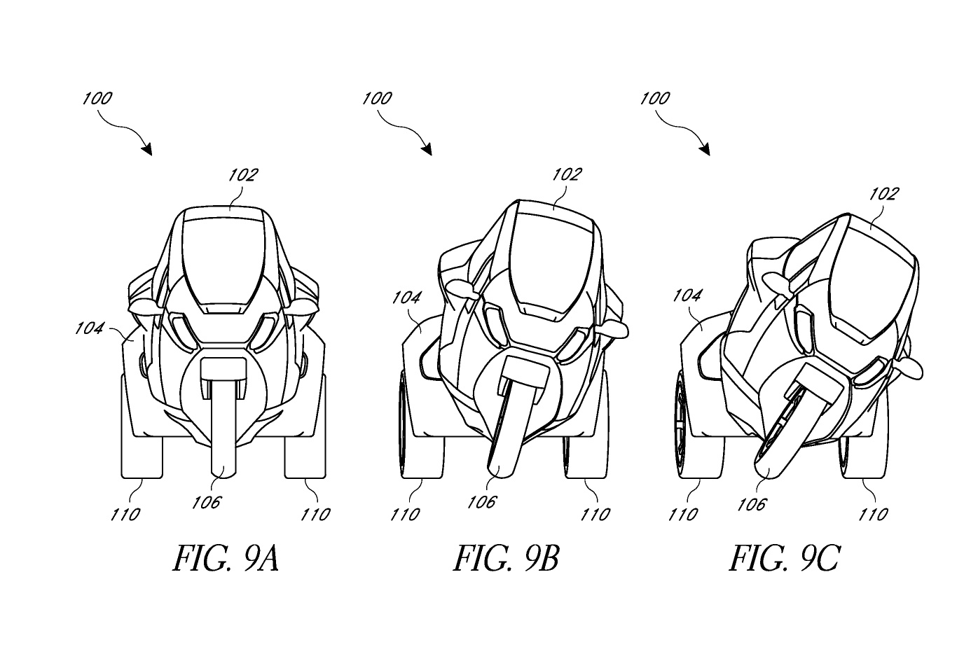

A front view of one configuration of a three-wheeled tilting vehicle is shown in various angle of lean in FIG. 9. FIG. 9A illustrates the vehicle in a neutral or non-leaning position with the forward chassis portion 102 substantially vertical. FIG. 9B illustrates an intermediate leaning position in which the forward chassis portion 102 is no longer substantially vertical but is leaned into a turn. The front wheel 106 is preferably counter-steered to induce vehicle lean and reduce the actuator force required to tilt or lean the forward chassis portion 102. The rear chassis portion 104 remains in a substantially vertical position and does not lean. In some configurations, including the illustrated configuration, the rear wheels 110 are steered into the turn for additional control and stability. FIG. 9C illustrates a maximum leaning position in which the forward chassis portion 102 is substantially tilted from a vertical position. As in FIG. 9B, the front wheel 106 is counter-steered though the front wheel 106 may be steered into the direction of the turn to help complete the turn. The rear wheels 110 may be further steered into the direction of the turn if additional steering or stability is needed as assessed by the ESC and the traction control system.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In particular, while the three-wheeled tilting vehicle and steering sub-assemblies have been described in the context of several embodiments, the skilled artisan will appreciate, in view of the present disclosure, that certain advantages, features and aspects of the three-wheeled tilting vehicle and steering sub-assemblies may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A three-wheeled vehicle, comprising:
a rearward chassis portion comprising a first rear wheel and a second rear wheel;
a forward chassis portion comprising a front wheel and a passenger compartment, wherein the forward chassis portion is rotatable relative to the rearward chassis portion about a tilt axis, and wherein the front wheel is rotatable about a steering axis;
a drive unit that drives at least one of the first rear wheel and the second rear wheel;
a steering unit that controls a rotational position of the front wheel about the steering axis; and
a tilt unit that controls a rotational position of the forward chassis portion about the tilt axis, the tilt unit comprising a drive gear carried by the rearward chassis portion and a driven gear carried by the forward chassis portion and driven by the drive gear, wherein when the drive gear is rotated in a first direction, the forward chassis portion is tilted in a first direction about the tilt axis and when the drive gear is rotated in a second direction, the forward chassis portion is tilted in a second direction about the tilt axis.

2. The three-wheeled vehicle of claim 1, wherein the steering unit further comprises a force feedback mechanism comprising at least one actuator and at least one sensor.

3. The three-wheeled vehicle of claim 1 further comprising a plurality of sensors, comprising: a steering input sensor that detects a position of and a torque applied to the steering input device, at least one speed sensor that detects a speed of at least one of the first rear wheel, the second rear wheel and the front wheel, a roll sensor that detects information regarding the vehicle with respect to a roll axis, a yaw sensor that detects information regarding the vehicle with respect to a yaw axis and a transverse acceleration sensor that detects acceleration along a transverse axis; and an electronic control unit that receives information from the plurality of sensors and, based on the information, issues one or more control signals to the steering unit and the tilt unit.

4. The three-wheeled vehicle of claim 3, wherein the drive unit, the steering unit and the tilt unit are controlled by the electronic control unit.

5. The three-wheeled vehicle of claim 3, wherein the electronic control unit steering unit counter-steers the front wheel to induce rotation of the forward chassis portion about the tilt axis.

6. The three-wheeled vehicle of claim 3, further comprising a traction control arrangement comprising a first brake and a second brake that selectively apply a braking force to a respective one of the first and second wheels, wherein when the forward chassis portion tilts in a first direction, the first brake is actuated by the electronic control unit and the second brake is not actuated and when the forward chassis portion tilts in a second direction, the second brake is actuated by the electronic control unit and the first brake is not actuated.

7. A three-wheeled vehicle, comprising:
a rearward chassis portion comprising a first rear wheel and a second rear wheel;
a forward chassis portion comprising a front wheel and a passenger compartment, wherein the forward chassis portion is rotatable relative to the rearward chassis portion about a tilt axis, and wherein the front wheel is rotatable about a steering axis;
a drive unit that drives at least one of the first rear wheel and the second rear wheel;
a steering unit that controls a rotational position of the front wheel about the steering axis;
a tilt unit that controls a rotational position of the forward chassis portion about the tilt axis;
a traction control arrangement comprising a first brake and a second brake that receives a signal from an electronic control unit to selectively apply a braking force to a respective one of the first and second wheels, wherein when the forward chassis portion tilts in a first direction, the first brake is automatically actuated and the second brake is not actuated and when the forward chassis portion tilts in a second direction, the second brake is automatically actuated and the first brake is not actuated.

8. The three-wheeled vehicle of claim 7, wherein the steering unit further comprises a force feedback mechanism comprising at least one actuator and at least one sensor.

9. The three-wheeled vehicle of claim 7 further comprising a plurality of sensors, comprising: a steering input sensor that detects a position of and a torque applied to the steering input device, at least one speed sensor that detects a speed of at least one of the first rear wheel, the second rear wheel and the front wheel, a roll sensor that detects information regarding the vehicle with respect to a roll axis, a yaw sensor that detects information regarding the vehicle with respect to a yaw axis and a transverse acceleration sensor that detects acceleration along a transverse axis; and the electronic control unit receives information from the plurality of sensors and, based on the information, issues one or more control signals to the steering unit and the tilt unit.

10. The three-wheeled vehicle of claim 7, wherein the electronic control unit is configured to direct the steering unit to counter-steer the front wheel to induce rotation of the forward chassis portion about the tilt axis.

11. The three-wheeled vehicle of claim 7, further comprising a lateral acceleration sensor configured to calculate the vehicle's acceleration in a lateral direction, a yaw sensor configured to provide information on the yaw position of the forward chassis portion, and a roll sensor configured to provide information on the roll position of forward chassis portion.

12. A three-wheeled vehicle, comprising:
a rearward chassis portion comprising a first rear wheel and a second rear wheel;
a forward chassis portion comprising a front wheel and a passenger compartment, wherein the forward chassis portion is rotatable relative to the rearward chassis portion about a tilt axis, and wherein the front wheel is rotatable about a steering axis;
a drive unit that drives at least one of the first rear wheel and the second rear wheel;
a steering unit that controls a rotational position of the front wheel about the steering axis;
a tilt unit that controls a rotational position of the forward chassis portion about the tilt axis;
a steering input device that receives steering input from a user of the vehicle;
a plurality of sensors, comprising: a steering input sensor that detects a position of and a torque applied to the steering input device, at least one speed sensor that detects a speed of at least one of the first rear wheel, the second rear wheel and the front wheel, a roll sensor that detects information regarding the vehicle with respect to a roll axis, a yaw sensor that detects information regarding the vehicle with respect to a yaw axis and a transverse acceleration sensor that detects acceleration along a transverse axis;
an electronic control unit that receives information from the plurality of sensors and, based on the information, issues one or more control signals to the steering unit and the tilt unit.

13. A method of controlling a three-wheeled vehicle having a rearward chassis portion comprising a first rear wheel and a second rear wheel, a forward chassis portion comprising a front wheel and a passenger compartment, wherein the forward chassis portion is rotatable relative to the rearward chassis portion about a tilt axis, and wherein the front wheel is rotatable about a steering axis, the method comprising:
receiving instructions from a vehicle operator to indicating a turn direction of the vehicle;
automatically applying a braking force to one of the first rear wheel and the second rear wheel in the direction of the turn and not to the other of the first rear wheel and the second rear wheel when an electronic control unit receives a signal indicative of a vehicle speed above 30 kilometers per hour;
tilting the forward chassis portion in the direction of the turn.

14. The method of claim 13 further comprising turning the front wheel in a counter-steering direction opposite the turn direction when a speed of the vehicle is above 30 kilometers per hour and subsequent to the turning of the front wheel in the counter-steering direction, tilting the forward chassis portion toward the turn direction.

15. A method of controlling a three-wheeled vehicle having a rearward chassis portion comprising a first rear wheel and a second rear wheel, a forward chassis portion comprising a front wheel and a passenger compartment, wherein the forward chassis portion is rotatable relative to the rearward chassis portion about a tilt axis, and wherein the front wheel is rotatable about a steering axis, the method comprising:
detecting an intended turn direction of the vehicle based on user input to a user steering input device;
turning the front wheel in a counter-steering direction opposite the intended turn direction;
subsequent to the turning of the front wheel in the counter-steering direction, tilting the forward chassis portion toward the turn direction.

16. The method of claim 15 further comprising automatically applying a braking force to a one of the first rear wheel and the second rear wheel in the direction of the turn and not to the other of the first rear wheel and the second rear wheel when an electronic control unit receives a signal indicative of a vehicle speed above 30 kilometers per hour.
